(19) United States
(12) Patent Application Publication
(10) Pub. No.: US 2003/0084352 A1
(43) Pub. Date: May 1, 2003

(54) Appliance security model system and method

(76) Inventors: Jeffrey D. Schwartz, Loveland, CO (US); Neal A. Krawetz, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/998,888

(22) Filed: Oct. 30, 2001

(51) Int. Cl. H04L 9/00

(52) U.S. Cl. 713/202

(57) ABSTRACT

An embodiment of the invention comprises an appliance security method, the appliance operable to be used by a consumer at a single user entry point and serviced using a unique security mechanism unique to the appliance. The method also comprises associating an appliance with a unique identifier, associating a unique security mechanism with the unique identifier, the unique security mechanism required to service the appliance.

Another embodiment of the invention comprises a security system for at least one appliance operable to be used by a consumer at a single user entry point and serviced using a security entry mechanism unique to the one of the at least one appliance, comprising a unique identifier to identify one of said at least one appliance, and wherein the unique security mechanism is required to service the one of the at least one appliance and is associated with the unique identifier.

### RELATED APPLICATIONS

This application is related to co-pending U.S. patent application Ser. No. ______ entitled Secure Boot Device Selection Method and System, filed on even date herewith.

This application is also related to co-pending U.S. patent application Ser. No. ______ entitled System and Method for Securing a Computer, filed on even date herewith.

### TECHNICAL FIELD OF THE INVENTION

The present invention relates generally to the field of processing systems and, more particularly, to a secure boot selection method and system appliance security model system and method.

### BACKGROUND OF THE INVENTION

Computer systems and appliances have become necessities for many consumers. For example, most homes have appliances such as video cassette recorders (VCRs) and personal computers (PCs). Recently, network appliances, such as dedicated email and browser platforms—as one example, Netpliance's i-opener product—and interactive television appliances, such as TiVo, have become popular. These appliances typically have a single user entry point, or interface.

TiVo is a dedicated appliance with a graphical user interface (GUI) that allows a user to automatically track, and digitally record, selected programs, and to pause, rewind and instantly replay television programs much like a VCR records and plays back video cassettes. TiVo is an appliance that is typically connected to the Internet through a dedicated line such as a digital subscriber line (DSL) or a cable modem line.

In the context of appliances, the issue of security becomes increasingly important. Unfortunately, although these appliances typically have a single user entry point such as the GUI discussed above, these systems typically utilize only a single static password, such as a login, as their security model. Moreover, these appliances each utilize not only the same security model, but also the same password. As a result, these systems suffer from a variety of disadvantages. For example, the static passwords may be easy to decode, and are thus susceptible to security breaches. Once a security breach has occurred, a user may access data or other files that were not intended to be accessed. This access allows these files, and thus an internal system configuration, to be altered. For example, a user might alter a configuration to temporarily operate with a larger disk drive than was shipped from the manufacturer. In such a scenario, any problems arising from such a configuration may cause the user to ship the unique appliance back to the manufacturer, allegedly under a manufacturer's warranty. As a result after the single password has been decoded, effective service may be prevented from being performed on the system. This scenario increases burdens on the manufacturer, such as increased shipping costs and extended troubleshooting times.

Furthermore, once the static password security model has been breached for one appliance, the password may be published and distributed without authorization, for example, by hackers via a web page. Once the password has been published, corresponding types of appliances using the same security model are susceptible to the same security breaches. Furthermore, once the security model has been so breached, files may be altered to allow unauthorized applications to be installed. In some cases, the corrupted appliances are used by the applications to invoke denial-of-service attacks on other locations that are connected to the network, such as Internet servers or Internet service providers. Because each of these appliances uses the same security model and password, these attacks may be of a sufficient number to bring down an entire site.

### SUMMARY OF THE INVENTION

An embodiment of the invention comprises an appliance security method, the appliance operable to be used by a consumer at a single user entry point and serviced using a unique security mechanism unique to the appliance. The method also comprises associating an appliance with a unique identifier, associating a unique security mechanism with the unique identifier, the unique security mechanism required to service the appliance.

Another embodiment of the invention comprises a security system for at least one appliance operable to be used by a consumer at a single user entry point and serviced using a security entry mechanism unique to the one of the at least one appliance, comprising a unique identifier to identify one of said at least one appliance, and wherein the unique security mechanism is required to service the one of the at least one appliance and is associated with the unique identifier.

Another embodiment of the invention comprises a security system application, the appliance operable to be used by a consumer at a single user entry point and serviced using at least one security mechanism unique to the appliance comprising application software residing on a computer-readable medium and operable to prevent unauthorized servicing of an appliance by using the at least one unique security mechanism, the at least one security mechanism associated with a unique identifier that is operable to identify the appliance.

### BRIEF DESCRIPTION OF THE DRAWINGS

For a more complete understanding of the present invention and the advantages thereof, references now made to the following descriptions taken in connection with the accompanying drawings and which:

FIG. 1 is a block diagram of an embodiment of a network appliance security model system utilizing teachings of the present invention; and

FIG. 2 is an example of a method that may be used to provide network appliance security utilizing teachings of the present invention.

### DETAILED DESCRIPTION OF THE DRAWINGS

From the foregoing, it may be appreciated that a need has arisen for providing improved protection of appliances from alteration, as desired. In accordance with the present invention, an appliance security model system and method are provided that substantially eliminate or reduce disadvantages and problems of conventional systems.

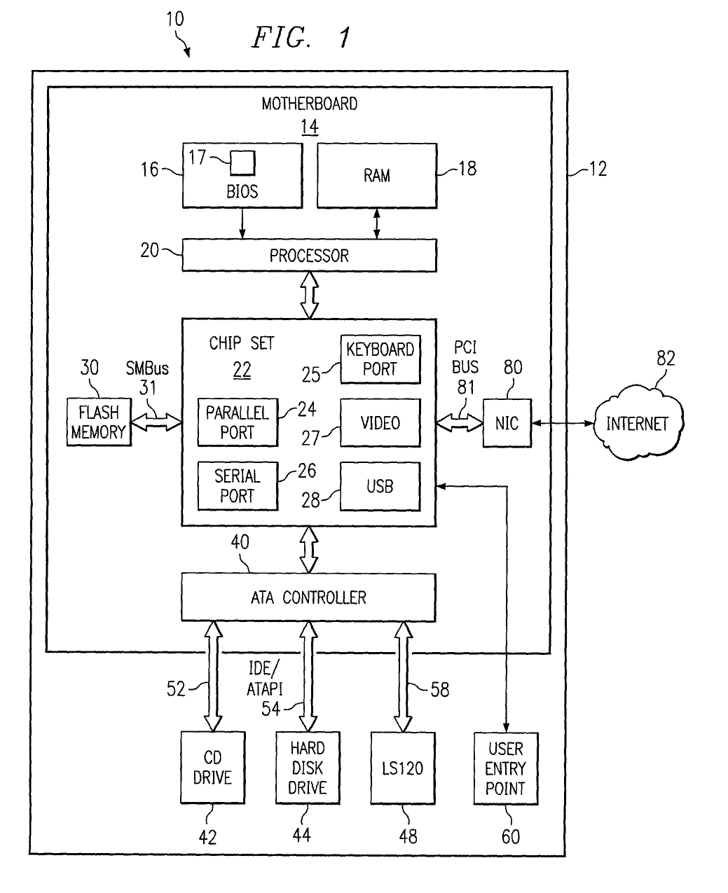

FIG. 1 is a block diagram of an embodiment of a security system 10 utilizing teachings of the present invention. Security system 10 includes an appliance 12 that has a motherboard 14. Appliance 12 may be a network appliance such as a digital entertainment center with a single user entry point 60 or interface, and is operable to process a plurality of media types, including music, “books on tape,” lectures, etc. To illustrate, if appliance 12 is a digital entertainment center, user entry point 60 allows a consumer-user to perform functions such as, for example, automatically tracking and digitally recording selected music files, and to pause, rewind and instantly replay music programs much like a VCR records and plays back video cassettes. User entry point 60 may be a GUI with functions such as those described above, or such as those presented with a word processing program such as Word, available from Microsoft Corporation. User entry point 60 does not enable the consumer-user to access, change, or move files, beyond the extent permitted by the dedicated functions in user entry point 60. Appliance 12 may be one of a variety of appliances now known or developed in the future. For example, appliance 12 may be an appliance substantially similar to a VCR whose dedicated function is to allow a user to, for example, play, rewind and record video cassettes. The invention contemplates the development of new technologies that encompass today's traditional household appliances such as, but not limited to, ranges, refrigerators, televisions, and others, whether or not they include a substantial amount of electronic circuitry or logic, such as a stereo. These appliances may be operated by a user through a user entry point 60. One example of a user entry point 60 is illustrated in FIG. 1, as coupled to chip set 22 where it may interact with a keyboard port 25, a video port 27, and a parallel port 24. For example, the user may operate a remote control device and/or front panel buttons (not explicitly shown) to input commands into appliance 12. The user may then receive output from appliance 12 using a variety of methods, including displays such as liquid crystal displays (LCDs) and other GUIs. Moreover, the invention contemplates a number of appliances that may be Internet-enabled; that is, these appliances may send and receive information over a network such as, but not limited to, the Internet, through one of many types of communication links. These communication links may be, for example, a dedicated line, such as a digital subscriber line (DSL) or a cable modem line. For example, and in a particular embodiment, appliance 12 may also include a network interface card (NIC) 80 coupled to chip set 22 through a PCI Bus 81. NIC 80 is coupled directly or indirectly to a network such as Internet 82 leading a variety of methods. For example, NIC 80 may include one or more communication functions such as a dial-up modem, Ethernet modem, and/or a modem that conforms with the Home Phoneline Network Alliance (HOMEPNA) using widely varying bandwidths. Appliance 12 may also be a general or a specific purpose computer, and may be a portion of a computer adapted to execute an operating system. Appliance 12 may be a wireless device, such as a cellphone, personal digital assistant, or an appliance. The present invention contemplates a variety of other representative configurations now known or that may be developed in the future.

Motherboard 14 includes a processor 20 coupled to a flash memory basic input/output system (BIOS) 16 and a random access memory (RAM) 18. BIOS 16 includes a power-on self-test module 17 for performing system initialization and tests. Motherboard 14 also includes an interface chipset 22 for communicating with input-output devices such as, but not limited to, a pointing device, keyboard, and a display device such as thermometer, scanner, or printer (not explicitly shown). In this embodiment, interface chipset 22 preferably includes parallel port 24, keyboard port 25, a serial port 26, video port 27, and a universal serial bus (USB) 28 to communicate with the various input/output devices. Motherboard 14 also includes a flash memory 30. In a particular embodiment, flash memory 30 may be a serial flash memory coupled to interface chipset 22 via a system management bus (SMBus) 31.

Appliance 12 may be coupled via motherboard 14 to a variety of boot devices using a variety of interfaces for reading and/or storing data. For example, in the embodiment illustrated in FIG. 1, motherboard 14 may be coupled to a CD drive 42 via an integrated device electronics/advanced technology attachment packet interface (IDE/ATAPI) bus 52. CD drive 42 may be used to read or store data such as an operating system and various other application modules or routines that may be used to boot appliance 12 in certain scenarios. Motherboard 14 may also be coupled to a hard disk drive 44 via bus 54. As one example, hard disk drive 44 may include an operating system and various other application modules or routines that may be used with the particular operating system. This arrangement may allow appliance 12 to be used in a variety of applications using different operating systems, as desired. Motherboard 14 may also be coupled to various other drive storage devices such as, but not limited to, and LS120 drive 48, via bus 58.

The manufacturer may identify each individual, or unique, appliance 12 with a unique identifier such as a serial number. Each of the plurality of service mechanisms has a method associated with it. This identifier will ensure that a particular security mechanism used are associated with that unique appliance, and only that unique appliance. That is, where at least one of the plurality of service mechanisms of appliance 12 is breached, the breach will only reach that particular unique appliance 12. Each of the security mechanisms is used to prevent unauthorized servicing of appliance 12. For example, the security mechanisms may be used to prevent a user from altering any files other than those he has created, such as music or other content files. To illustrate, a servicer, who is authorized, may validly use a security mechanism applicable to that unique appliance to access, delete, move, or otherwise alter system, configuration and all content files operatively associated with, or accessible by, appliance 12 when that authorized user services the appliance. The user may not access, delete, move, or otherwise alter the files available to the authorized servicer.

In a particular embodiment, a single password may be used for multiple security mechanisms. For example, a first password may be used at a prompt screen for BIOS 16. An authorized user may then enter the password in response to the prompt screen (not explicitly shown). For example, a log-in prompt may be accessible through a keystroke pattern by using user entry point 60. The log-in may use a rotating password that is specified for a varying number of characters that may be entered using user entry point 60 by, for example, depressing keys or buttons on a remote or keypad. Similarly, keystrokes may be used using entry point 60 to enter in the password for BIOS 16. Other security mechanisms may include a rotating password for a root login such as is known in the art. A third security mechanisms may include using a locking identifier to restrict booting of hard drive 44 to a motherboard of the appliance as discussed below. These three security mechanisms, in this scenario discussed above, include a root login that accesses a file system for appliance 12 a prompt screen for BIOS 16, and a locking identifier for hard disk drive 44, may be used separately or in combination.

Each unique appliance 12 may also be associated with a login password and BIOS password. In a particular embodiment, this password may be rotated. That is, the password changes after each use, or a predetermined number of uses. These passwords may be used to ensure that only authorized users may service appliance 12.

One example for providing a security drive lock may be found in co-pending patent application entitled System and Method for Securing a Computer, filed on even date herewith. This method and system compares a locking identifier such as a serial number of hard drive 44 with an identifier prestored in flash memory 30, upon boot up of hard drive 44. If these identifiers do not match, BIOS 16 is prevented from starting up an operating system on processor 20. This method and system includes restricting booting of a hard drive 44 to a motherboard of the appliance by using locking identifiers. This ensures that booting of any replacement hard drive or using an unauthorized CD in CD drive 42 will be unsuccessful;, access and alteration of the locking identifiers is substantially prevented.

Although in the above embodiment three security mechanisms are described, the invention contemplates fewer or more security mechanisms. The collection of security mechanisms used may be denoted as the security model. The security model may utilize a variety of methods, depending on the implementation. For example, each of the security mechanisms described above may be implemented in software such as, but not limited to, an encoded password or locking identifier that may be stored in a secure storage medium such as flash memory 30 in, for example, a table.

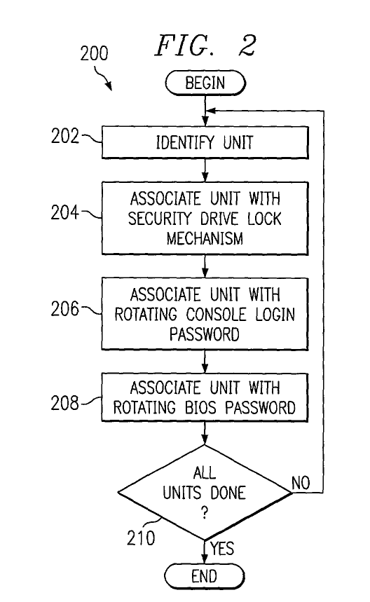

FIG. 2 is an example of a method that may be used to provide network appliance security utilizing teachings of the present invention. Method 200 begins at step 202, where a unique appliance 12 is identified. For example, a unique appliance may be identified with a serial number or other identifier, such as a model number. In step 204, the unique appliance is associated with a security drive lock mechanism.

As discussed previously, in step 206 the unique appliance 12 may be associated with a rotating login password and, in a particular embodiment, one security mechanism may include using a console or administrative login. This login may display a GUI for an administrator or other security personnel to enter a password. This password may be rotated using a number of methods. For example, many methods now known include passwords that rotate in synchronization with a random number generator. This random number generator may be used to generate a particular password that is matched to a master password list created with the same random number generator. This password list is maintained in a secure place such as, but not limited to, a manufacturer's server, where it may be retrieved when service to each unique appliance 12 is required. Other methods now known or developed in the future may be used to generate the rotating password.

In step 208, the unique appliance 12 is associated with a rotating BIOS password. In a particular embodiment, this password may be the same password as the password in step 206. Alternative embodiments include generating or deriving this password from the console login password, or generating a password unique from the console login password. Also in particular embodiment, the BIOS password may be retrieved from serial flash memory 30 and used to boot appliance 12 when desired.

Each password may be constructed as desired. For example, a password may be a password string consisting of a predetermined number of letters and/or numbers or other characters that may be uniquely identified. The password(s) may be stored in serial flash memory 30 and retrieved to be matched. For example, a serial number may be loaded on a manufacturing floor by a variety of methods including bar code scanning. This serial number may then be stored in flash memory 30. Upon initial start up of the system, an install program such as, for example, provided. Once hard drive 44 is available for boot after identification from password(s) in steps 204, 206, and/or 208, a boot program including an OS kernel may be loaded into RAM 18 and then executed.

In step 210, the method queries whether a security model has been executed for all unique appliances. If not, the method returns to step 202, where another unique appliance 12 is identified. The method then proceeds to perform steps 204, 206, and 208 for that particular unique appliance. The method then continues until a security model for all unique appliances has been completed. If all unique appliances are completed in step 210, then method ends.

At least one embodiment of the invention enables control of copyrighted material. As one example, content from a CD may be read and encoded into a file on appliance 12 to prevent the content from being duplicated, transmitted, and/or published around the world without providing an owner with additional royalty. The present invention prevents unauthorized users from accessing and/or altering files on appliance 12, such as data and OS files, thereby permitting the copyrightholders' monitoring of a physical media with the particular file. As one example, audio files such as MP3 or .WAV files may be played utilizing appliance 12 with an application such as a MP3 player or a Realplayer, available from RealNetworks, Inc., in a jukebox manner. The user entry point is typically a GUI that enables playing, pausing, forwarding and other functions for performing a music file. Using the present invention, a user may be maintained and securely associated with appliance 12. A user is prevented from downloading the files to multiple remote devices such as a, for example, a car, personal digital assistant (PDA), or other device. Thus, the user may only record onto a prepaid royalty media; that is, physical media associated with that file. Upon first receiving appliance 12, the user may also initialize the disk media, which may be, for example, a compact disc (CD) or by loading a personal digital assistant (PDA) device. From there, the user may then load a remote device such as a car CD player, using, for example, a wireless communication link.

Moreover, by preventing alteration of the configuration of appliance 12, thereby reduces or eliminates the returns to manufacturers of defective items that have been altered by the user. Further, preventing the alteration of appliance 12's configuration prevents denial of service attacks from being launched from appliance 12. For example, an unauthorized user who might have gained access to, and placed executable code on, appliance 12, may invoke that executable code by a signal over the network to all devices upon which the user has placed that executable code. In response, all of the altered appliances launch enough network traffic to produce a denial-of-service attack.

What is claimed is:

1. An appliance security method, the appliance operable to be used by a consumer at a single user entry point and serviced using a security mechanism unique to the appliance, comprising:
associating an appliance with a unique identifier;
associating the unique security mechanism with the unique identifier, the unique security mechanism required to service the appliance.

2. The method of claim 1, wherein the unique security mechanism comprises associating a security drive lock mechanism with the appliance with a locking identifier.

3. The method of claim 1, wherein the unique security mechanism comprises associating with the appliance a password.

4. The method of claim 1, wherein the unique security mechanism comprises associating with the appliance a basic input/output system (BIOS) password.

5. The method of claim 1, further comprising associating a plurality of unique security mechanisms required to service the appliance with the unique identifier.

6. The method of one of the at least one claim 3, wherein the password is rotated.

7. A security system for at least one appliance operable to be used by a consumer at a single user entry point and serviced using a security mechanism unique to one of the at least one appliance, comprising:
a unique identifier to identify one of the at least one appliance; and
wherein the unique security mechanism is required to service the one of the at least one appliance and is associated with the unique identifier.

8. The security system of claim 7, wherein the unique security mechanism comprises associating a security drive lock mechanism with the one of the at least one appliance and with a locking identifier.

9. The security system of claim 7, wherein the unique security mechanism comprises associating with the one of the at least one appliance a password.

10. The security system of claim 7, wherein the unique security mechanism comprises associating with the one of the at least one appliance a basic input/output system (BIOS) password.

11. The security system of claim 7, further comprising a plurality of unique security mechanisms required to service the one of the at least one appliance and associated with the unique identifier.

12. The security system of claim 7, wherein the password is rotated.

13. The security system of claim 7, wherein the one of the at least one appliance comprises a digital entertainment center appliance.

14. The security system of claim 7, wherein the user entry point comprises a graphical user interface.

15. A security system application, the appliance operable to be used by a consumer at a single user entry point and serviced using at least one security mechanism unique to the appliance, comprising application software residing on a computer-readable medium and operable to prevent unauthorized servicing of an appliance by using the at least one unique security mechanism, the at least one security mechanism associated with a unique identifier that is operable to identify the appliance.

16. The security system of claim 15, wherein the at least one unique security mechanism comprises associating a security drive lock mechanism with the appliance with a locking identifier.

17. The security system of claim 15, wherein the at least one unique security mechanism comprises associating with the appliance a password.

18. The security system of claim 15, wherein the at least one unique security mechanism comprises associating with the appliance a basic input/output system (BIOS) password.

19. The security system of claim 15, further comprising a plurality of unique security mechanisms required to service the appliance and associated with the unique identifier.

20. The security system of claim 15, wherein the password is rotated.
